(19) United States
(12) Patent Application Publication
(10) Pub. No.: US 2007/0223058 A1
(43) Pub. Date: Sep. 27, 2007

(54) Multispectral Scanner With Enlarged Gamut, in Particular a Single-Pass Flat-Bed Scanner

(76) Inventors: Pascal Cotte, Tilly (FR); Damien Dupraz, Sartrouville (FR)

Correspondence Address: NIXON & VANDERHYE, PC, 901 NORTH GLEBE ROAD, 11TH FLOOR, ARLINGTON, VA, 22203, US

(21) Appl. No.: 11/628,611

(22) PCT Filed: May 30, 2005
(86) PCT No.: PCT/FR05/01322

§ 371 Date: Apr. 25, 2007

(30) Foreign Application Priority Data
Jun. 7, 2004 (FR) 0406098

(51) Int. Cl. H04N 1/193

(52) U.S. Cl. 358/474

(57) ABSTRACT

The scanner comprises an integrated photosensitive linear sensor (20) comprising N parallel lines of photosites, where N≧4, and preferably N≧6, with each line of photosites being associated with a respective bandpass optical filter. For each scanning step and for each pixel of the analyzed line, it delivers N corresponding quantized partial measurement values, each representative of the spectral reflectance of the document sensed through respective ones of the N filters. Spectral reconstruction means operate using an extrapolation method based on training from reference color samples, having a memory (42) storing a knowledge base formed from known spectral reflectance values of said reference samples, and a neural network (40) receiving as inputs the N quantized partial values and delivering as output at least one reconstituted quantized value representative of the spectral reflectance of the corresponding pixel of the document.

The invention relates to the field of calorimetric analysis.

The sensation of color results from perceiving radiation covering a given set of wavelengths.

A color is characterized by a parameter known as “spectral reflectance” which describes in the form of a continuous characteristic (spectrum) the distribution of the proportions of the different wavelengths over the extent of the visible range.

This spectral reflectance can be determined directly by a spectrophotometer or by a spectroradiometer, which are instruments provided with a dispersive system such as Newton's prism, enabling a selective band of wavelengths to be projected onto a sensor. Nevertheless, those instruments are complex and difficult to use, which means they are restricted to laboratory and metrology applications.

In conventional digital imaging, colors are usually analyzed using three color filters: red, green, and blue (RGB three-color selection). In order to refine color description and discrimination, it is also possible to perform multispectral acquisition, e.g. using six filters, thereby doubling the number of digital values that are acquired. The color information that results from such analysis can be described and stored in the form of three (or six) coordinates defined in the CIE colorimetry system, and represented relative to the CIE chromaticity diagram in a two-dimensional space.

It is also possible to use a calorimeter, which is a measuring instrument provided with a sensor, a light source, and a set of filters, generally four filters, enabling a standardized CIE pair to be produced comprising a standardized illuminant and a standard observer. For a given CIE illuminant, the calorimeter serves to obtain coordinates in a color space of the CIE L*u*v, CIE L*a*b, XYZ, etc. type, with colorimetric systems themselves being well known and abundantly referenced.

For more ample information on this topic, reference can be made in particular to Acquisition and reproduction of color images: calorimetric and multispectral approaches by J. Y. Harderberg, PhD dissertation, Ecole nationale supérieure des télécommunications, Paris, France, 1999, or to Physique de coleur: de l'apparence colorée à la technique colorimétrique [The physics of color: from colored appearance to colorimetry technique] by R. Sève, Masson, France, 1996.

A color acquisition system using RGB filters or a calorimeter nevertheless provides only discrete color coordinate values, three values or six values depending on the number of filters, and does not provide a continuous reflectance spectrum which is the only way of representing the physical reality behind the perception of color.

Knowledge of only three or six color coordinates does not make it possible to obtain perfect characterization of a given color. Various methods (explained below) have been proposed for reconstituting a spectral reflectance characteristic from color coordinates; for example the so-called “interpolation” method enables spectral reflectance to be approximated on 30 points on the basis of knowledge of only six color coordinates.

Nevertheless, the reconstruction algorithms that have been implemented until now do not make it possible starting from only six color coordinates (and a fortiori from only three color coordinates) to reconstruct certain spectra that correspond to subtle shades of color, some of which are in widespread use in painting: it is thus not possible to find the subtle shades of a “cobalt blue”, an “aureolin yellow”, a “smaragdine green” or a “celadon green”, an “andrinople red”, an “eburnine white”, etc. which are replaced by colors that approximate thereto.

In order to increase the fidelity which colors are reproduced, in particular when performing very high resolution and very high fidelity digitizing of collections held by museums, proposals have been made to further increase the amount of color information, e.g. by subdividing the light spectrum using thirteen filters mounted in a filter-carrier turret, as can be done with the “Jumboscan” camera developed by the supplier Lumière Technology SA.

Nevertheless, that constitutes an installation which although capable of high fidelity reproduction, is expensive and complex to implement: careful preparation of filters having the desired characteristics (the filters are interference filters having very narrow passbands); increasing numbers of analysis passes (as many passes as there are different filters); pass reproducibility requiring a mechanical system that is extremely accurate (the thirteen scanned images must be superposable, pixel on pixel, to within one micrometer); correction of chromatic aberrations in the optical system, etc. This means that its use is restricted to special applications, essentially in the field of museography.

As a result there exists a considerable need that has yet to be satisfied for a scanner that is simple and efficient in structure, and thus capable of being made at low manufacturing cost, and that enables very high fidelity colorimetric analysis to be undertaken of a document, with the analysis being effective over the entire visible color space, giving the possibility of distinguishing very subtle shades of color.

To this end, the invention provides a multispectral scanner of known type, e.g. as disclosed in above-mentioned WO-A-00/25509, i.e. comprising: a linear photosensitive sensor suitable for analyzing a line of a document in a transverse direction; a set of N bandpass optical filters, with N≧4, preferably N≧6; lighting means suitable for forming an illuminated strip on the document in the region being analyzed by the sensor; and motor means suitable for driving a controlled scan of the document in successive steps in a longitudinal direction. For each scanning step and for each pixel of the line under analysis, the scanner is suitable for delivering N corresponding quantized partial measurement values, each representative of the spectral reflectance of the document as sensed by the sensor through respective ones of the N filters.

In a first aspect of the invention, spectral reconstruction means are provided for spectrally reconstructing the image of the document and operating using an extrapolation method based on training with reference color samples, said means comprising: a memory storing a knowledge base made from known spectral reflectance values for said reference samples; and a neural network receiving as its inputs, for each pixel, said N quantized partial measurement values, and outputting at least one reconstituted quantized value representative of the spectral reflectance of the corresponding pixel of the document.

In a second aspect of the invention, means are provided for applying bootstrap type iterative resampling processing to the N measurement values before the N measurement values are applied to the inputs of the neural network.

As explained in the description below, the invention can be implemented using a conventional RGB scanner mechanism, e.g. a conventional A3 or A4 format office flat-bed scanner.

The sensor is preferably an integrated component having N parallel lines of photosites, with each line of photosites being associated with a respective one of the N bandpass optical filters, and with the entire document being scanned in a single pass. Analyzing the document in a single pass serves in particular to avoid any need to have recourse to precision mechanical systems for scanning of the kind used in prior art systems where it is necessary to ensure that multiple passes coincide reproducibly.

The above configuration of the invention can be applied most advantageously to a flat-bed type scanner having an exposure window for receiving the document to be scanned.

Unlike conventional RGB scanners having a “gamut”, i.e. a sensed color range that occupies only 50% to 70% of the spectrum, a multispectral flat-bed scanner suitable for covering 100% of the visible color spectrum presents a considerable advantage in a very large number of industrial and artistic applications, including the following:
the “packaging” and advertising field, where colors are usually defined on the basis of four, five, or six colors, where the additional reference colors include specific Pantone (registered trademark) colors which in 60% of cases lie outside the gamut of RGB scanners; the ability to recognize a Pantone color in an image by means of a device that is as simple to use as an office scanner constitutes very considerably progress for professionals in this field;
digitizing documents produced by artists, e.g. using airbrushes or other tools in association with inks or pigments that are difficult to bring within the RGB gamut;
in science, measuring the colors of test strips or solutions in laboratory applications;
in the textile field, digitizing samples: textiles are printed using dyes that present a gamut that is extremely large;
calorimetric inspection in production lines, e.g. in the field of printing, to verify at the outlet from a printing machine that samples of a document as actually printed do indeed comply with the original color selection delivered to the printer; and
in the field of illustration or photography, reproducing documents containing subtle shades of color, such as water colors, or old books, in which the illustrations were made using specific stains or inks that can be reproduced faithfully only by using multispectral digitizing.

The application of the invention to a multispectral single-pass flat-bed scanner is nevertheless not limiting, and it will be understood that the invention can be applied to other types of scanner, for example to digital photographic systems or to systems such as that described in WO-A-00/25509 (Lumière Technology SA) where a photosensitive sensor scans an image plane formed by a lens of an analysis chamber, the article under observation itself being illuminated by a narrow strip of light that is moved synchronously with the scanning of the sensor.

The neural network of the spectral reconstruction means of the invention is preferably a network having multiple thresholds, suitable for receiving as inputs the N measurement values, for applying specific weightings to the N values, and for outputting a plurality of individual reconstituted quantized values associated with corresponding spectral components of the reflectance of the pixel. Under such circumstances, the neural network may output a number N′ of individual reconstituted quantized values that is greater than the number N of measurement values, in particular a number N′ of at least 15 values, preferably of at least 25 values, and more preferably 30 values, for a number N of measurement values that is equal to 6 or to 7.

There follows a description of an embodiment of the invention given with reference to the accompanying drawings.

FIG. 1 is a diagrammatic view showing the configuration of the various mechanical components of a single-pass flat-bed scanner.

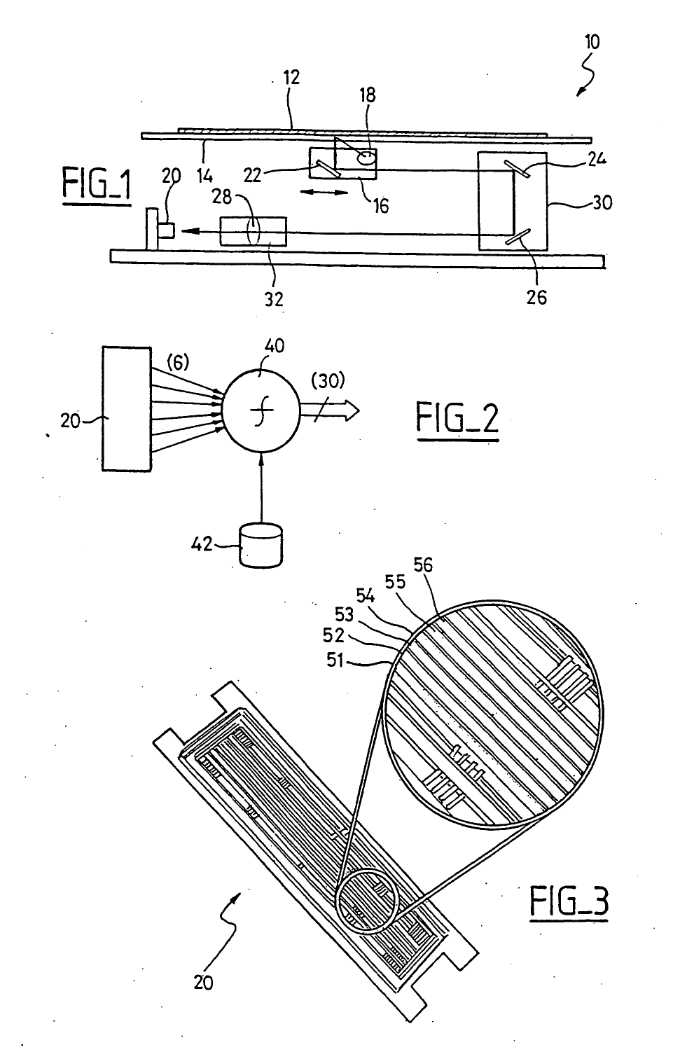

FIG. 2 shows the principle of spectrum reconstruction by means of a neural network.

FIG. 3 is a view of an integrated multispectral CCD sensor, which view is enlarged in part to show the series of associated filters.

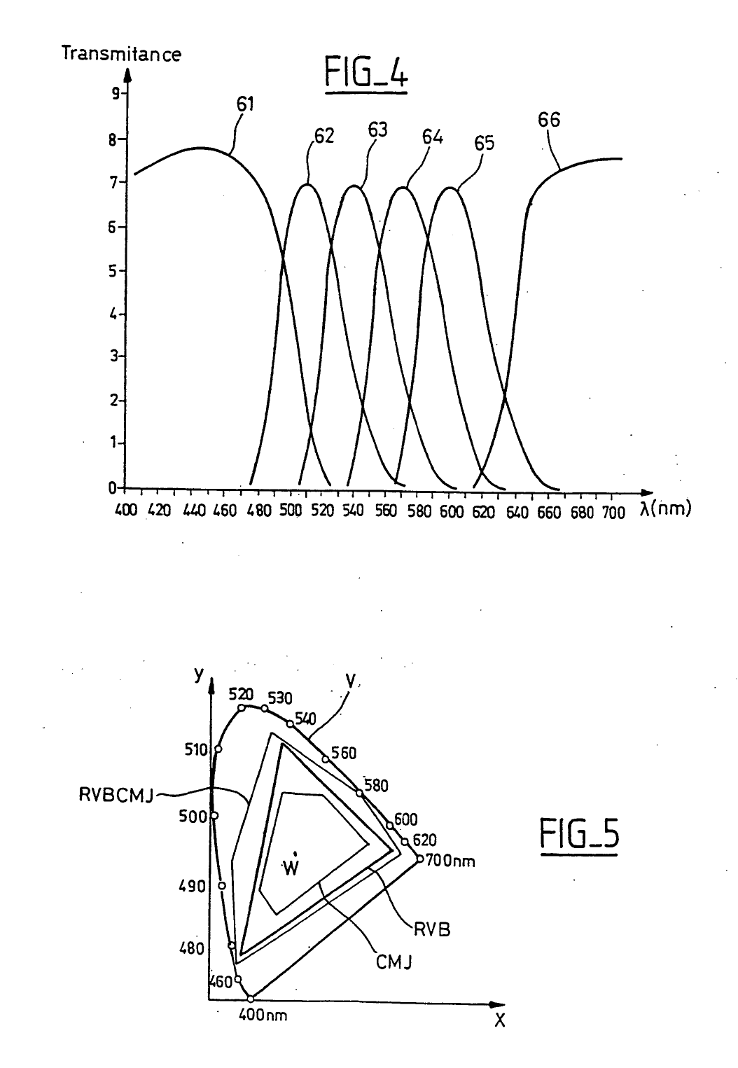

FIG. 4 is a graph showing the transmittance curves of the various filters of the FIG. 3 sensor.

FIG. 5 shows the chromaticity diagram in the CIE system, showing the respective gamuts of different colorimetry analysis systems, relative to the extent of the visible color space.

FIG. 1 shows a general structure of a multispectral flat-bed scanner to which the invention can advantageously be applied.

As mentioned above, this type of scanner is not limiting and the invention can be implemented with other analyzer devices, for example the document reproduction chamber described in WO-A-00/25509, where an image of the document is formed on an image plane that is scanned by a sensor driven by a micrometer system.

The mechanism of a single-pass flat-bed scanner, e.g. of the A4 or A3 office scanner type, is itself well known.

The scanner 10 serves to scan a document 12 laid flat against a stationary scanner window 14. First moving equipment 16 carries lighting means 18 suitable for illuminating a narrow transverse strip of the document 12. The equipment 16 is movable in linear translation in a direction perpendicular to the illuminated scan line, and an optical assembly is provided for forming an image of said line on a stationary linear sensor 20 via mirrors 22, 24, and 26, and via a lens 28. The mirror 22 is secured to the moving equipment 16, while the mirrors 24 and 26 are mounted on other moving equipment 30 that is adjustable in position, and the lens 28 is mounted on a support 32 that is movable so as to vary the optical magnification factor.

The sensor 20 is a multispectral sensor that typically delivers six color signals in six distinct bands.

Nevertheless, the invention is not limited to this number (six) of bands; that merely corresponds to the best compromise at present. It should merely be understood that the number of bands is greater than the three bands of RGB sensors, that present shortcomings as set out above, and less than the twelve or thirteen bands of the complex apparatuses mentioned above and used for example in the field of museography, which, because of their complexity, cannot be implemented in simple manner, in particular in the form of a single-pass scanner. The use of a number of filters less than six, for example five filters or even only four filters, comes within the ambit of the invention, but will naturally give a result that is qualitatively inferior.

The problem of the invention essentially consists in reconstituting a reflectance spectrum from these six values, and thus in calculating intermediate values (an operation referred to as “reconstruction”), while minimizing the interpolation noise added by the operation.

This is a known problem as numerous proposals have been made for solving it.

These proposals can be classified in three main methods.

A first method referred to as “direct reconstruction” consists in characterizing all of the elements of the image acquisition and digitizing system: a spectrum curve for the lighting device, the spectral sensitivity specific to the sensor, the respective transmittances of the filters used, and the transmittances of the various components in the optical system. Once the acquisition system has been characterized in this way, it is then possible to construct a direct link between the stimulation and the response of the system in the form of a matrix operator having K rows by N columns, where K is the number of filters used by the system and N is the number of samples that result from the digital quantization.

Nevertheless, that direct method presents the drawback of requiring prior characterization of each component of the system, implying a certain amount of experimentation (measuring the spectral sensitivity of the sensor using a monochromator, measuring the transmittance of the optical system and of the filters with a spectrophotometer, etc.). It is also very sensitive to problems with electrical noise, which appears to be difficult to quantize as such. For these reasons, it is at present of interest above all on theoretical grounds and has not given rise to concrete utilizations other than in experimental applications.

A second method, referred to as “reconstruction by interpolation”, involves solely the response of the camera to a perfect white reference. After normalization relative to the standard white, the camera is considered as a spectrum sampler, a point of the spectrum curve being measured once every 40 nanometers (nm) in the visible range, for example. Intermediate points of the spectrum are then reconstructed by an interpolation method, e.g. by a cubic spline method or by a modified discrete sine transform (MDST), so as to obtain a spectrum that is reconstructed at points that are spaced apart, for example, by 10 nm, 5 nm, or 1 nm.

That interpolation method presents the advantage of requiring knowledge only of the response of the camera, using digital processing on the basis of conventional algorithms. Nevertheless, it assumes that the spectrum to be reconstructed is a spectrum presenting a profile that is relatively smooth; the algorithms used for reconstructing the missing points are incapable of detecting a narrow peak in the spectrum, which peak will be smoothed out and the reconstituted information will be deformed. In addition, a large amount of interpolation noise becomes superposed thereon, and that degrades the performance of the method very quickly.

In practice, spectrum analysis must be capable of being used on spectra that are complex, for example those of pigments used in painting and presenting a spectrum profile that is highly particular, such that if it is smoothed by the reconstruction algorithm it will be immediately perceived as being deformed by an observer trained to distinguish between subtle shades of color and substitutions by means of a color that is close. In addition, implementing that technique with an acceptable degree of fidelity in reproducing colors implies a relatively large number of filters in order to obtain sufficient starting samples, typically eleven or thirteen filters, which restricts its use to cameras that are relatively complex and does not enable it to be implemented in the form of a mass-produced scanner, e.g. having a color analysis system relying on six bands only.

The third method, to which the present invention belongs, is known as “indirect reconstruction” or “reconstruction by training”. Essentially, this method uses a standardized color chart that makes it possible, by extrapolation, to model a transfer function between reference spectra as measured on the chart for each of the samples, and the corresponding responses of the camera.

As explained below, the invention proposes a certain number of improvements to that known method of indirect reconstruction in order to be able to determine the looked-for transfer function with performance that is much better than that which it has been possible to provide in the past, and also making it possible to implement the method on the basis of information delivered by a sensor that analyzes the spectrum over a small number of bands, typically only six bands (where six is a value that is typical, but naturally not limiting).

The implementation of the method by the invention is shown diagrammatically in FIG. 2.

The sensor 20 of the scanner is typically constituted by a six-filter sensor, as mentioned above, and it therefore delivers six quantized color-measurement values for each pixel. These values are applied to a neural network 40 having six inputs and thirty outputs (assuming that it is desired to reconstruct the spectral reflectance over thirty points). The neural network 40 is associated with a memory 42 that stores a knowledge base made up of known spectral reflectance values for a certain number of reference samples, advantageously samples selected as a function of the intended application: for example, in applications in the field of museography or of illustration, a database built up from the 300 main pigments used in painting. This knowledge base serves to determine the various weightings applied by the neural network.

The neural network 40 may optionally be made in the form of a specific digital signal processor integrated in the multispectral sensor 20.

The sensor 20 used for implementing the invention is advantageously an integrated sensor of the kind shown in FIG. 3, in the form of a strip having six (or possibly seven) lines of photo-sensitive sites, e.g. 10,000 or 12,000 photo-sensitive sites each, with each of the lines being associated with a corresponding filter 51 to 56 with mass coloration. The respective spectral responses 61 to 66 of these filters are shown in FIG. 4.

The multispectral sensor 20 is combined with the mechanical and optical scanning system of the scanner in the same manner as a conventional three-color sensor of the prior art, thus making it possible to deliver simultaneously for each pixel of the line of the document being scanned a series of 6×12 bits (or 7×12 bits) constituting the quantized measurement values that are applied to the neural network 40.

The invention makes it possible with a sensor having only six filters to obtain a gamut covering the entire visible range, enabling very subtle color shades to be reproduced with very great fidelity, with performance that is much better than that which it has been possible to offer in the past with six-color analysis systems or a fortiori with three-color systems.

FIG. 5 is thus a chromaticity diagram in the CIE colorimetry system showing the visible range V (which can be covered in full by a scanner of the invention) and relative thereto the respective restricted gamuts obtained using CMY and RGB three-color analyses, or using six-color RGBCMY analysis.

Furthermore, the sensor of the invention is easy to integrate in a mass-produced scanner of the single-pass type, and produces results that are equivalent to those which until now have required the use of a complex apparatus with eleven or thirteen filters, and requiring as many analysis passes.

There follows a more detailed description of the manner in which the samples picked up by the sensor are processed in order to achieve such results.

Principle of Indirect Multispectrum Reconstruction

The starting point of this method consists in using a multispectral camera to form an image of a chart having P samples (e.g. P=250 or 300 samples) of reference colors that are representative of the documents that are to be scanned, and that have spectral reflectance curves that are known accurately, e.g. previously determined by means of a spectrophotometer.

For each sample, a vector cₚ of dimension K is obtained containing the responses of the camera in the various bands that are analyzed (where K is the number of filters used in the acquisition system, typically K=6 or 7), and an associated vector rₚ of dimension N representative of the associated spectral reflectance, previously determined by means of a spectrophotometer (where N is the number of measured spectrum points, typically N=30 points).

The problem consists in discovering from the data as determined in this way (the starting reference data and the corresponding responses of the camera), the corresponding transfer function which is a matrix operator Q of dimension N×K such that:
R=QC
where R is a matrix of dimensions N×P of the vectors rₚ, and C is a matrix of dimension K×P of the vectors cₚ. It can be shown that this expression can be rewritten as follows:
Q=RC^{t}(CC^{t})⁻¹
which can be expressed in the following form:
Q=R pinv(C)
where the notation pinv(C) designates the pseudo-inverse of the matrix C, i.e.:
pinv(C)=C^{t}(CC^{t})⁻¹
This is a matrix that is easily calculated using algorithms that are themselves known.
Optimization by Applying a Bootstrap Method

In a first aspect of the invention, the starting data used in implementing the indirect reconstruction is subjected to statistical processing of the bootstrap type.

The bootstrap method is itself known, e.g. from Bootstrap methods: another look at the jackknife, by B. Efron in Annals of Statistics, 7, pp. 1-26, 1979. It is a computer resampling technique serving to measure the accuracy of statistical estimates by providing confidence intervals on the estimate of a statistical population. To do this, resampling the data makes it possible to incorporate by statistical inference information that is contained in data associated with its probabilistic distribution.

The starting point of the invention consists in using this statistical bootstrap processing technique for processing color signals in order to improve the reconstruction of a spectrum reference.

For this purpose, the above-defined matrices R and C are resampled by randomly selecting their columns, using a uniform probabilistic distribution for this selection.

This operation (a function written below as resample(.)) consists in producing from a given matrix another matrix that comprises the columns as resampled in random manner. In the resulting matrix, there will therefore be columns that are repeated, and conversely, some of the columns of the original matrix will no longer be found in the resampled version.

To implement the invention, the proposed algorithm forms a reconstruction operator Q from matrices obtained by resampling the above-defined matrices R and C, and it evaluates the distance between the initial operator Q and the resulting operator Q.

A large number of operators Q are calculated in this way, together with their respective distances from a test data set Rₜₑₛₜ and Cₜₑₛₜ, after which the algorithm selects as the final result the operator that presents the shortest distance (in the least squares sense).

The algorithm can be expressed in pseudo-code as follows:
For i=1 . . . I
   Rᵢ=resample(R)
   Cᵢ=resample(C)
   Qᵢ=Rᵢ pinv(Cᵢ)
   errorᵢ=∥QᵢCₜₑₛₜ−Rₜₑₛₜ∥²
End For
Select Qᵢ having the smallest errorᵢ
   where I is the number of iterations.

The function resample(.) transforms R and C in the same manner with the same random selection on each iteration so that both matrices contain columns that correspond.

In an optimized variant of this bootstrap method, the selection is performed in non-random manner, in order to increase the accuracy of the method and achieve convergence on the final operator that is faster.

This improvement implements colorimetric video acquisition performed concurrently with analysis of the reference color sample chart.

If a lighting source is used in combination with appropriate filters enabling the standard observer to be associated with a standardized illuminance, it is possible under such circumstances to emulate the behavior of a colorimeter and to obtain accurately the chromatic coordinates in a single system.

This chromatic data can advantageously be delivered by a secondary sensor directly integrated in the scanner, and delivering information simultaneously with the scanning of the document.

The colorimetric video acquisition serves to locate the greatest color differences between the response of the camera and the corresponding chromatic coordinates. This knowledge of the greatest differences can then be used for introducing favorable bias when selecting which samples to eliminate in the bootstrap algorithm so as to improve its effectiveness by concentrating its effect on those samples of the chart that require the most processing in order to optimize the transfer function that is to be determined.

Using a Neural Network

In another aspect of the invention, multispectral reconstruction by training is implemented by means of a neural network.

This aspect of the invention is preferably provided in combination with the above-explained bootstrap processing which constitutes a statistical engine that is advantageously applicable to the samples before they are applied to the neural network.

Nevertheless, these are two techniques that are distinct and that can be used independently of each other, even though when used in combination they naturally produce results that are particularly advantageous.

Neural networks are generally defined as being networks comprising a very large number of simple processors (neurons) that are connected together by communication paths (connections) conveying digital data encoded in various manners, the neurons operating only on the inputs applied via their respective connections.

Neural networks can be represented in the form of a matrix having N inputs and N′ outputs, with each of the output values being dependent on the set of N input values as a function of weightings allocated to each neuron. Individual neurons are organized in subgroups each performing independent processing with the result being forwarded to the following subgroup: information thus propagates through the neural network, with the option of applying output values to preceding subgroups (back-propagation).

The weightings of the connections of the neurons are adjusted by a data set determined on the basis of prior training. The knowledge of the network (training) is thus stored in the various weights, which are capable of adapting during processing. The neural network subsequently presents behavior that takes account of the parameters input during the training stage, thus making it suitable for implementing a certain kind of generalization on the basis of particular cases.

A detailed study of this concept can be found in particular in Mixture density network by C. M. Bishop in Neural Computing Research Group Report NCRG/4288, Aston University, United Kingdom, 1996.

In the invention, where it is desired to perform multispectral reconstruction, the training stage consists in acquiring the multiple samples of the reference color sample chart (typically 250 to 300 samples) and in storing the data in a knowledge base containing the corresponding weights for all of the neurons in the network. The behavior of the network thus integrates the knowledge of the spectral characteristics of the samples in the chart.

1. A multispectral scanner comprising:
a photosensitive linear sensor (20) suitable for analyzing a line of a document in a transverse direction;
a set of N bandpass optical filters (51-56) where N≧4;
lighting means (18) suitable for forming an illuminated strip on the document in the region analyzed by the sensor; and
motor means suitable for causing the document to be scanned in controlled manner in successive steps in a longitudinal direction;
the scanner being suitable for delivering, for each scanning step and for each pixel of the analyzed line, N corresponding quantized partial measurement values, each representative of the spectral reflectance of the document sensed by the sensor through a respective one of the N filters;
the scanner being characterized:
in that spectral reconstruction means are provided for spectrally reconstructing the image of the document and operating using an extrapolation method based on training with reference color samples, said means comprising:
a memory (42) storing a knowledge base made from known spectral reflectance values for said reference samples; and
a neural network (40) receiving as its inputs, for each pixel, said N quantized partial measurement values, and outputting at least one reconstituted quantized value representative of the spectral reflectance of the corresponding pixel of the document.

2. The scanner of claim 1, in which:
the sensor (20) is an integrated component having N parallel lines of photosites, with each line of photosites being associated with a respective one of the N bandpass optical filters; and
said scanning over the extent of the document is scanning performed in a single pass.

3. The scanner of claim 1, in which N≧6, preferably N=6.

4. The scanner of claim 2, of the flat-bed scanner type having an exposure window (14) for receiving the document go be scanned.

5. The scanner of claim 1, in which the neural network (40) is a network having multiple thresholds, suitable for receiving as inputs the N measurement values, for applying weightings specific to the N values, and for outputting a plurality of individual reconstituted quantized values associated with corresponding spectral components of the reflectance of the pixel.

6. The scanner of claim 5, in which the neural network outputs a number N′ of individual reconstituted quantized values that is greater than the number N of measurement values.

7. The scanner of claim 5, in which the number N′ of individual reconstituted quantized values is at least 15 values, preferably at least 25 values, more preferably 30 values, for a number N of measurement values equal to 6 or to 7.

8. The scanner of claim 1, in which said spectral reconstruction means for reconstructing the image of the document comprise means for applying bootstrap type iterative resampling processing to the N measurement values prior to applying said N measurement values to the inputs of the neural network.
